(19) United States
(12) Patent Application Publication
(10) Pub. No.: US 2024/0102602 A1
(43) Pub. Date: Mar. 28, 2024

(54) METHOD FOR WELDING AND ASSEMBLING A COMPONENT

(71) Applicant: ANASTASIOS RIZOPOULOS, VASILIKA THESSALONIKIS (GR)

(72) Inventor: ANASTASIOS RIZOPOULOS, VASILIKA THESSALONIKIS (GR)

(21) Appl. No.: 18/274,822

(22) PCT Filed: Oct. 5, 2021
(86) PCT No.: PCT/GR2021/000059

§ 371 Date: Jul. 28, 2023

(30) Foreign Application Priority Data
Jan. 29, 2021 (GR) 20210100056

(51) Int. Cl. F16L 59/20; B21C 37/08; B29C 65/00

(52) U.S. Cl. CPC F16L 59/20; B21C 37/08; B29C 66/1162; B29C 66/723; B29L 2023/225

(57) ABSTRACT

The invention relates to a method of welding and assembling a component, where two or more parts of pre-insulated pipes (1) are welded together to form components of two or three parts. The pre-insulated pipes (1) consist of an outer casing (2), an inner casing (3) and an intermediate insulation (4). The outer casing (3) during the process is beveled, the insulation (4) is cleared and thermal welding is carried out with the corresponding part of another pipe. After the resulting component has cooled, the gap between the outer casings (2) thereof is filled with polymer resin.

### FIELD OF ART

The invention relates to the field of engineering and more specifically to mechanical elements and in particular to general measures for the production and maintenance of the efficient operation of machinery or plant. Even more specifically, it relates to pipes, connections or fittings and generally to thermal insulation means. Specifically, it refers to a method for welding and assembling a component.

### BACKGROUND OF THE INVENTION

The method for welding and assembling a component disclosed in the present invention has not been disclosed in the prior art.

To date, the process of welding and assembling a component requires the welding and assembly of a service component made of plastic or metal, i.e. a pipe, depending on the way of welding provided for each material, so that we get its final shape. Then, welding and assembly of the outer plastic or metal casing is carried out, similarly depending on the intended way of welding the material. The service pipe is inserted into the outer casing and by means of hasps and supports it is ensured that the polyurethane to be injected will be retained inside the component. This is followed by the injection of polyurethane through a special hole, which is closed at the end with a cap. Then a period of about 10 minutes is allowed to elapse, for the polyurethane to swell and stabilize. Then the cap is removed and materials ensuring waterproofing are placed. Finally, the hasps are removed.

The above procedure, which is widely used to date, is very expensive and often does not prove to be extremely accurate in different types of materials. This makes the methodology slow, expensive, with large loss of non-reusable materials and often inefficient as to the final product produced.

It is thus an object of the present invention to deal with the aforementioned disadvantages and shortcomings of the prior art by proposing a method of welding and assembling pre-insulated components.

Another object of the present invention is to provide a method of welding and assembly which enables faster welding and assembly of the pre-insulated components.

It is a further object of the present invention to provide a method of welding and assembling components, which allows the creation of two or three part components.

A further object of the invention is to disclose a method for welding and assembling components, which ensures waterproofing of the resulting product, by filling the resulting gaps between the outer casings of the pipes, with polymer resin.

These and other objects, features and advantages of the invention will become apparent in the following detailed description.

### BRIEF DESCRIPTION OF THE DRAWINGS

The invention will become apparent to those skilled in the art with reference to the accompanying drawings in which it is presented in an illustrative non-limiting manner.

FIG. 1 shows a section of a pre-insulated pipe.

FIG. 2 shows a plan view of an assembled pre-insulated two-part component.

FIG. 3 is a plan view of a pre-insulated assembled three-part component.

### DETAILED DESCRIPTION OF A PREFERRED EMBODIMENT

Referring now to the accompanying drawings, we will describe exemplary applications of the method of welding and assembling pre-insulated components.

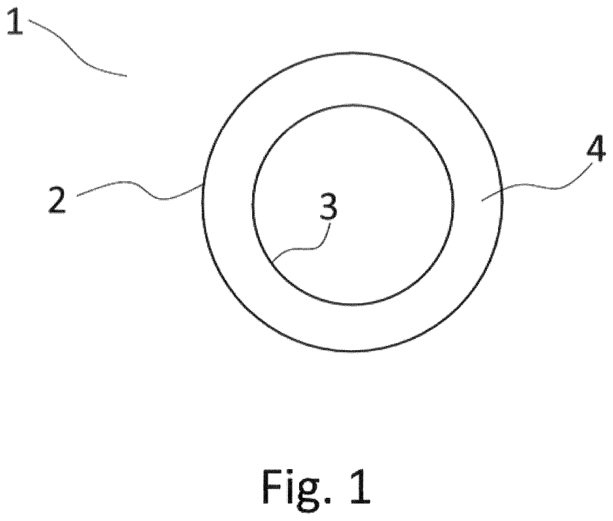

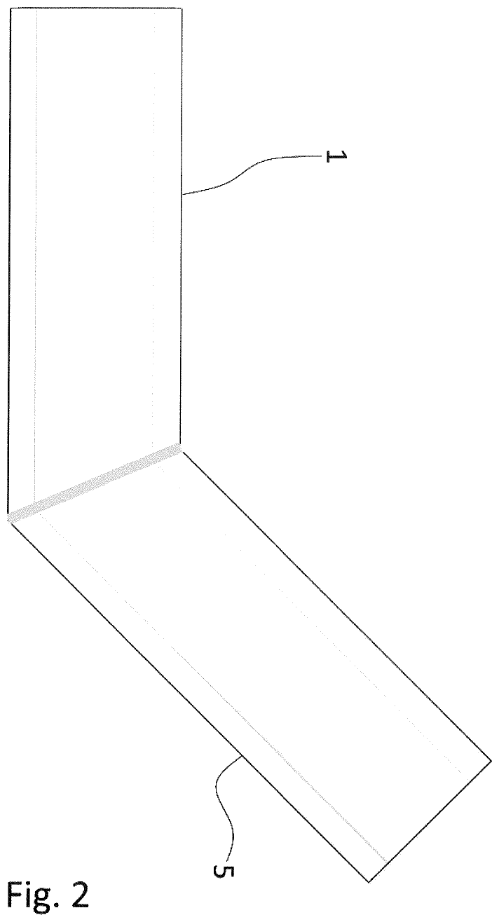

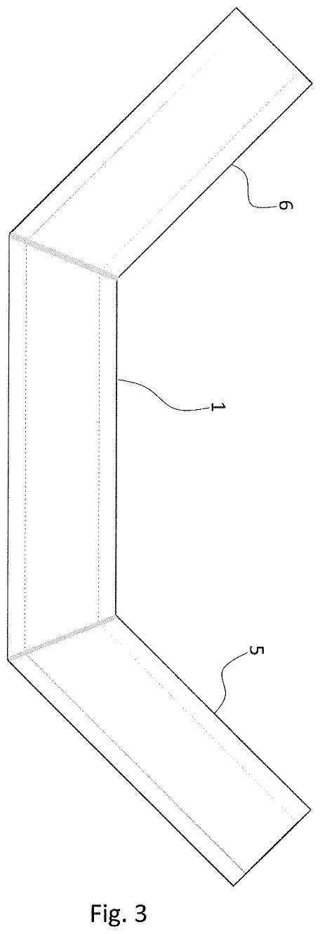

In the application of this method, a pre-insulated pipe (1) is obtained, i.e. a pipe made of plastic or metal and of suitable cross-section for the respective use, consisting of an outer casing (2), FIG. 1, inner casing (3) and intermediate insulation (4), which, by way of example, but not restrictively, is made of polyurethane. The outer casing (2) of the pipe is beveled using a suitable cutting machine. A similar procedure is followed for the beveling of the second pipe part (5), FIG. 2, or the second pipe part (5) and the third pipe part (6), FIG. 3, depending on the type of component. Using a special machine, which is advantageously a clearing disc, the insulation (4) is cleared from the beveled ends of each pipe. At this point special care is required so as not to scratch or cut the inner casing (3), which is the service pipe, i.e. the pipe through which water passes.

Once the process of clearing the insulation (4) from the beveled ends is completed, the thermal welding of the outer casings (2) of the parts of the two pipes follows. This is followed by the cooling and the stabilization of the welding, the gap remaining after the welding of the two or three parts, between their outer casings (2), being filled with polymer resin. For example, as a polymer resin can be used elastic mastic, which is applied using a special cartridge and waiting until it stabilizes, to ensure the watertightness of the components.

It should be noted at this point that the description of the invention has been made with reference to illustrative embodiments, to which it is not limited. Therefore, any change or modification in terms of shape, dimensions, morphology, materials used and components of construction and assembly, as long as they are not a new inventive step and do not contribute to the technical development of the already known are considered contained in the purposes and aspirations of this invention.

1. A method for welding and assembling a component, where at least two pre-insulated pipes (1), (5) consisting of an outer casing (2), an inner casing (3) and an intermediate insulation (4) are beveled in their outer casing (2), insulation (4) is cleared, their outer casings (2) are thermally welded and then cooled, characterized in that the insulation (4) gap between their outer casings (2) is filled with polymer resin.
